(19) United States
(12) Patent Application Publication
(10) Pub. No.: US 2007/0147275 A1
(43) Pub. Date: Jun. 28, 2007

(54) Wireless network system

(75) Inventors: Pin-Chuan Wang, Taipei (TW); Sung-Chi Chen, Taipei (TW); Chia-Wei Chan, Taipei (TW)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/645,695

(22) Filed: Dec. 27, 2006

(30) Foreign Application Priority Data
Dec. 27, 2005 (TW) 94146806

(51) Int. Cl. H04B 7/00

(52) U.S. Cl. 370/310

(57) ABSTRACT

A wireless network system communicates a wireless network with a destination, and includes a wireless base station for receiving or transmitting data via the wireless network. A coupling portion is set on the wireless base station. A router has a conducting portion, which is electrically connected to the coupling portion for receiving or transmitting the data from or to the desired destination.

### FIELD OF THE INVENTION

The present invention relates to a wireless network system, and more particularly to a wireless network system that includes a wireless base station and a router, and that permits the user to separate the wireless base station from the router or couple the two together depending on the seating environment of the wireless network system.

### BACKGROUND OF THE INVENTION

In order to catch up with the development in the Internet and to enable the computer user to be connected to the Internet free from the cabled network, a wireless network environment is needed. To create the wireless network environment, a client must install a wireless network card in his PC, and then the client's PC can be connected to the intended network via an Access Point, i.e. the Access Point will connect the PC to the Internet for transmitting or receiving wireless signals via the wireless network. The Access Point plays the role of a transmission medium between the wireless network and the Internet. In other words, the Access Point serves as a bridge for interconnecting the local area network (LAN) and the wireless network WLAN. Generally speaking, the Access point includes a box having a dimension similar to a lunchbox, and is adapted to be connected to a network for establishing communication for access to the Internet. A PC (personal computer) or handheld electronic device provided with a wireless LAN card can share or access the information from the network via the Access Point. In addition, since the Access Point possesses the network control ability, it can also control the electronic device provided a wireless LAN card.

FIG. 1 shows a prior art wireless base station 100 having a built-in router 102 and an antenna unit 104. During forming of a wireless network, the wireless base station 100 is generally mounted at a relatively high elevation in order to permit the clients of the WLAN to have an effective transmission quality. Therefore, the wireless base station 100 is generally designed and manufactured in compact size so as to be portable and to facilitate hanging of the same on a wall or mounting of the same on a high rack.

However, the easy-to-hang wireless base station 100 has simple function and therefore only suitable for home use or offices. An external connection cable (not shown) is required for connecting the aforementioned wireless base station to a power source in order to supply electrical power required by the wireless base station. In addition, the wireless base station 100 must also be equipped with a power supply, thereby limiting the option for seating the prior art wireless base station.

In order to provide a solution to the power supply problem shown in FIG. 1, the IEEE 802.3af specification has proposed PoE (Power over Ethernet) technology that can supply electrical power to the electronic appliances, where it would be inconvenient or unfeasible to supply power separately. The PoE system uses standard twisted-pair cable to transmit electrical power along with data for powering wireless LAN Access Points, IP telephones, webcam, Ethernet hubs and computers. Since power is supplied to the remote devices over the network, no additional power-coupling source is required, thereby enhancing the selection for installing places. The installation of the wireless base station is not restricted by the power supply source.

FIG. 2 shows another prior art wireless base station that includes a built-in router (not visible) and a PoE system 202 for providing electrical power over the network and an antenna unit 204.

A wireless base station for industrial use must possess relatively large function ability, hence the power supply for maintenance of the PoE system occupies a majority of the space. The whole assembly therefore must be enclosed within a metal shield so as to overcome the standard test. The metal shield should be grounded to prevent the same from being disturbed by nearby electromagnetic fields. However, it generally happens that the rack (made from metal), upon which the metal shield is seated, is located not far from the ground, thereby lowering the wireless transmission quality.

### SUMMARY OF THE INVENTION

It is the object of the present invention to provide a wireless network system that enables the user to separate the wireless base station with respect to a router or couple the two together depending on the seating environment of the wireless network system so as to enhance the option for selection of the mounting position.

In one aspect of the present invention, a wireless network system is provided for communicating a wireless network with a destination. The wireless network system includes a wireless base station for receiving or transmitting data via the wireless network, and a coupling portion is set on the wireless base station; and a router having a conducting portion which is electrically connected to the coupling portion for receiving or transmitting the data from or to a destination.

The wireless network system further includes a connecting cable for electrically coupling the wireless base station to the router.

In the wireless network system of the present invention, connection of the coupling portion of the wireless base station with the conducting portion of the router enables flow of electrical power into the wireless base station.

In a second aspect of the present invention, a wireless base station is provided for transmitting or receiving a data via a wireless network. The wireless base station includes a coupling portion for electrically connecting with a router in order to receive or transmit the data from or to a destination.

In a third aspect of the present invention, a router is provided to include a conducting portion which is electrically connected to a wireless base station for receiving or transmitting a data from or to a destination.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a schematic view of a prior art wireless base station having a built-in router;

FIG. 2 is a schematic view of another prior art wireless base station having a built-in router and PoE system for power supply;

FIG. 3A is a topside view of a wireless base station of the present invention;

FIG. 3B is a bottom view of the wireless base station of the present invention;

FIG. 4A is a topside view of a router of the present invention;

FIG. 4B is a topside view illustrating the wireless base station connecting to the router of the present invention;

FIG. 5A is a lateral side view illustrating the wireless base station and the router for forming a wireless network system of the present invention;

FIG. 5B is a lateral side view of the wireless network system of the present invention, in which, the wireless base station and the router are connected to each other in an up-and-down direction;

FIG. 6A is a lateral side view of the wireless network system of the present invention, illustrating a prior state, in which, the wireless base station and the router are not connected to each other;

FIG. 6B is a lateral side view of the wireless network system of the present invention, illustrating how the wireless base station is connected to the router;

FIG. 7 is a lateral side view of the wireless network system of the present invention, illustrating how the wireless base station and the router are connected to each other in a snap-fit manner;

FIG. 8A is a lateral side view of the wireless network system of the present invention, illustrating a prior state, in which, the wireless base station is not capped onto the router;

FIG. 8B is a lateral side view of the wireless network system of the present invention, illustrating how the wireless base station is capped onto the router;

FIG. 9A is a lateral side view of the wireless network system of the present invention, illustrating a prior state, in which, the wireless base station is not inserted into the router; and

FIG. 9B is a perspective side view of the wireless network system of the present invention, wherein, the wireless base station is inserted into the router from a rear side.

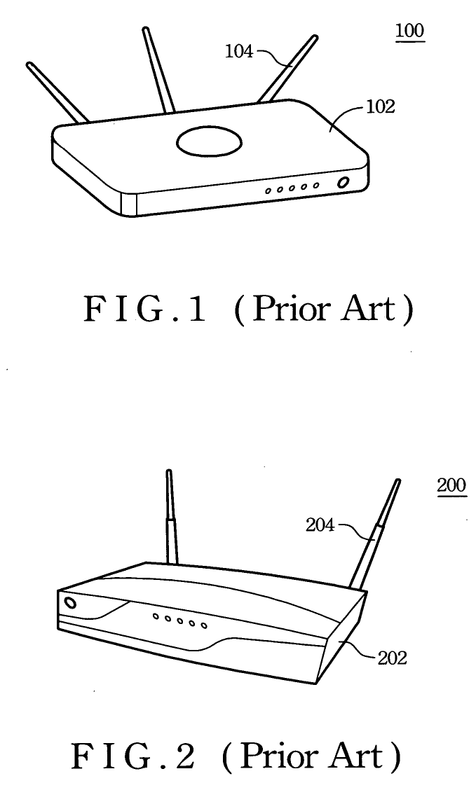

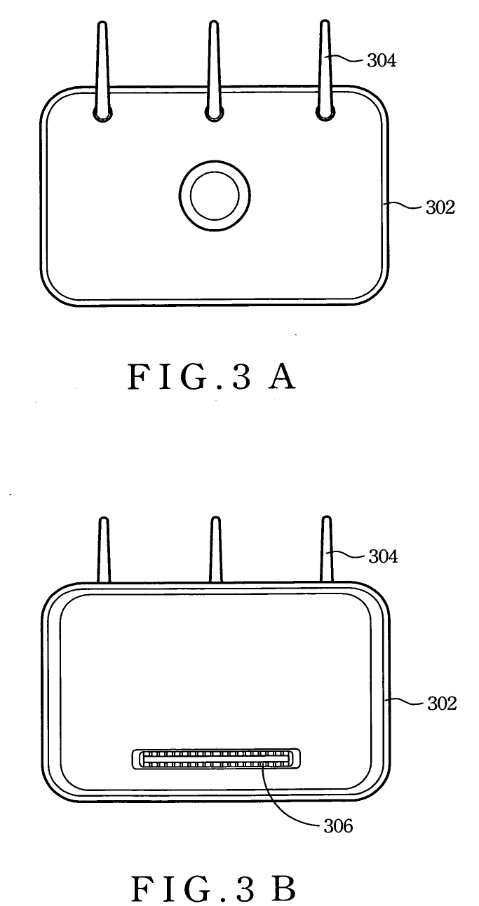

### DETAILED DESCRIPTIONS OF THE PREFERRED EMBODIMENTS

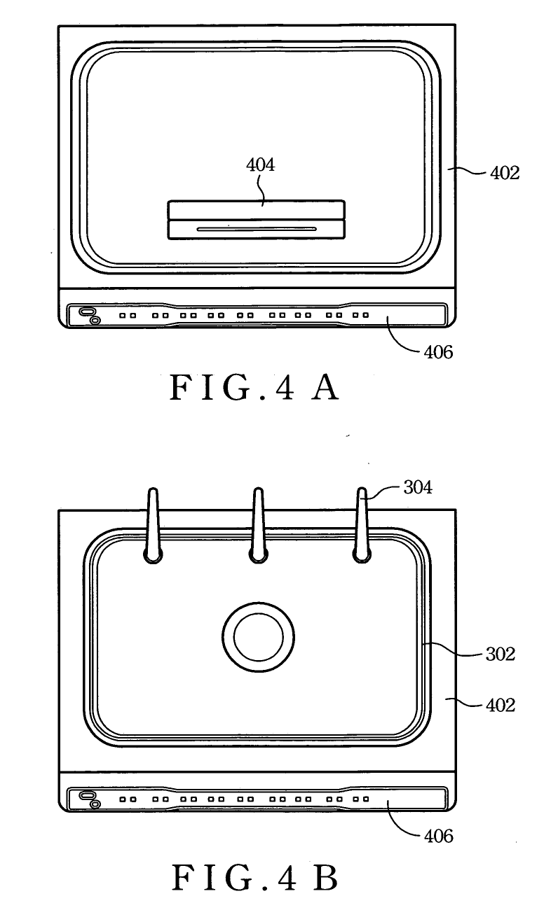

FIG. 3A is a topside view of a wireless base station of the present invention. FIG. 3B is a bottom view of the wireless base station of the present invention. FIG. 4A is a topside view of a router of the present invention. FIG. 4B is a topside view illustrating the wireless base station connecting to the router of the present invention. The wireless network system according to the present invention includes the wireless base station 302 and the router 402.

In one embodiment of the present invention, the wireless base station 302 has a coupling portion 306 and an antenna unit 304 for transmission of data signal via the wireless network after processing.

The router 402 has a conducting portion 404 and an indicator bulb 406. The conducting portion 404 is electrically connected to the coupling portion 306 of the wireless base station 302 for receiving or transmitting the data after certain procession steps to a destination, i.e. the Internet.

When the indicator bulb 406 is lighted, it indicates that the power supply, the connection network, etc. are in normal condition. The router 402 is ready for carrying out or performing its duty. However, the limitation should not restrict only thereto.

There are several ways or methods of coupling the wireless base station 302 to the router 402, such as along an up-and-down direction, along a front-and-rear direction, snap-fit manner, press-fitted manner, insert-into type from a rear side, and cap-into type. The coupling method can be designed according to the user's wishes. For better understanding of the wireless network system of the present invention, some methods for connecting the wireless base station 302 to the router 402 are shown in the following paragraphs.

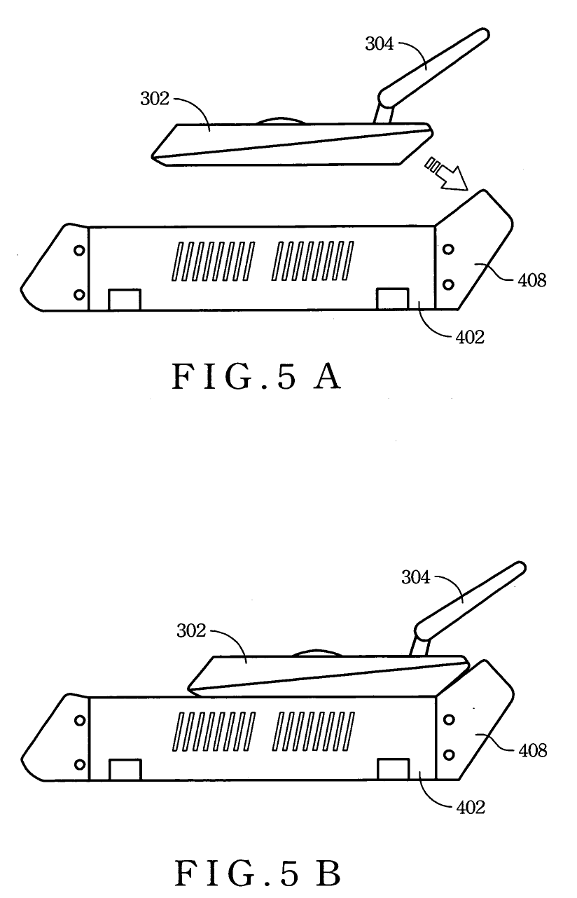

FIG. 5A shows a lateral side view the wireless base station 302 and the router 402 for forming one embodiment of the wireless network system of the present invention. As illustrated in FIG. 5B, the wireless base station 302 and the router 402 are connected to each other in an up-and-down direction.

In the aforementioned embodiment, the router 402 has a supporting portion 408 for supporting the entire portion of the wireless base station 302 thereabove when the wireless base station 302 is connected electrically to the router 402 in the up-and-down direction.

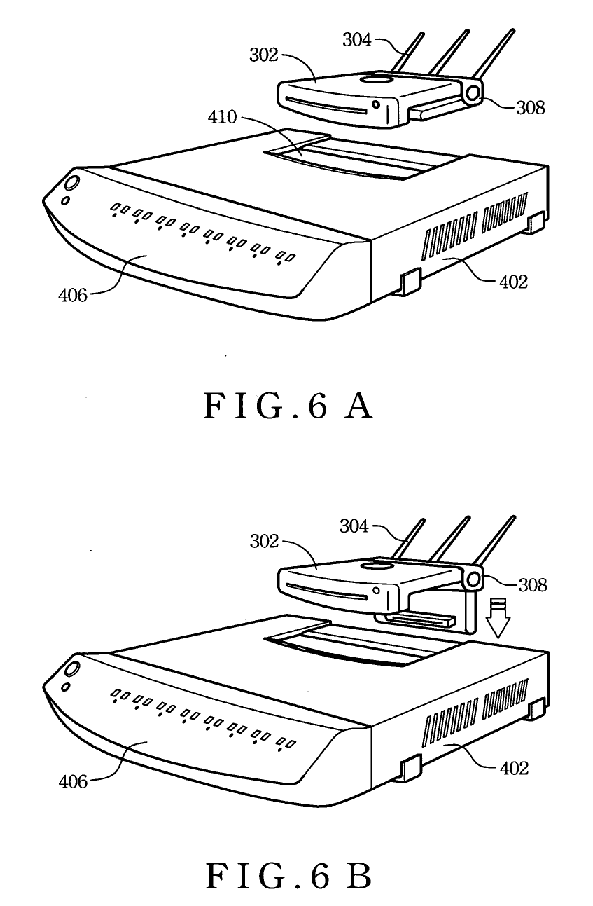

FIG. 6A is a lateral side view of the wireless network system of the present invention, illustrating a prior state, in which, the wireless base station 302 and the router 402 are not connected to each other. FIG. 6B is a lateral side view of the wireless network system of the present invention, illustrating how the wireless base station 302 is connected to the router 402 in a front-and-rear direction.

The wireless base station 302 has a foldable portion 308 folded in a normal condition and unfolded in a use condition. In order to permit the wireless base station 302 to be connected electrically to the router 402 along the front-and-rear direction, the foldable portion 308 is unfolded and is docked onto the router 402 along the arrow direction shown in FIG. 6B.

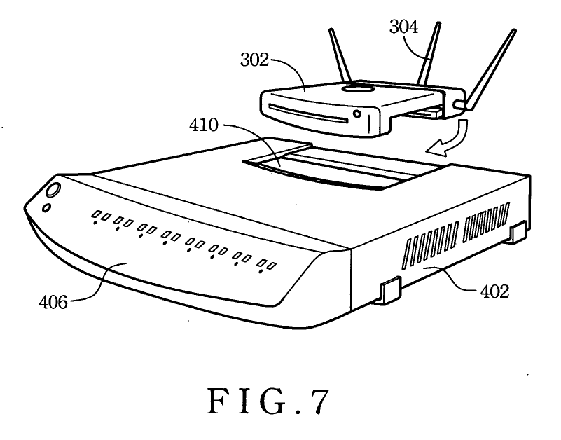

FIG. 7 is a lateral side view of the wireless network system of the present invention, illustrating how the wireless base station 302 and the router 402 are connected to each other in a snap-fit manner.

In this embodiment, the router 402 is formed with an accommodating recess 410. The coupling portion 306 (see FIG. 3A) of the wireless base station 302 is snap-fitted along the arrow direction into the accommodating recess 410 of the router 402 so that the router connects with the wireless base station in the snap-fit manner.

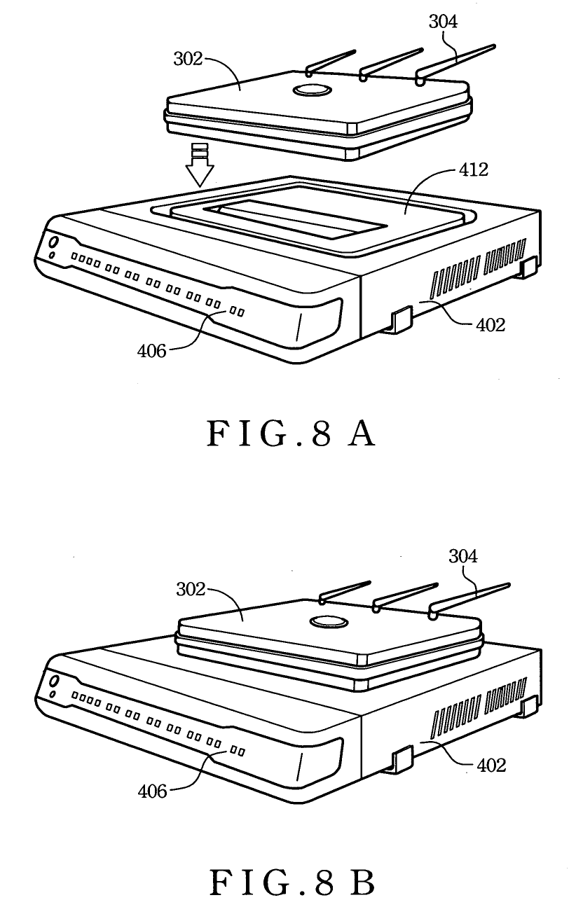

The FIG. 8A is a lateral side view of the wireless network system of the present invention, illustrating a prior state, in which, the wireless base station 302 is not capped onto the router 402. FIG. 8B is a lateral side view of the wireless network system of the present invention, illustrating the wireless base station 302 is capped onto the router 402. As shown, the router 402 is formed with an accommodating recess 410 for accommodating the wireless base station 302 when the wireless network station 302 is capped onto the router 402. Note that the bottom surface of the accommodating recess 410 is formed with a groove 412 for receiving the coupling portion 306 (not visible) of the wireless base station 302 such that the coupling portion 306 is connected to the conducting portion 404.

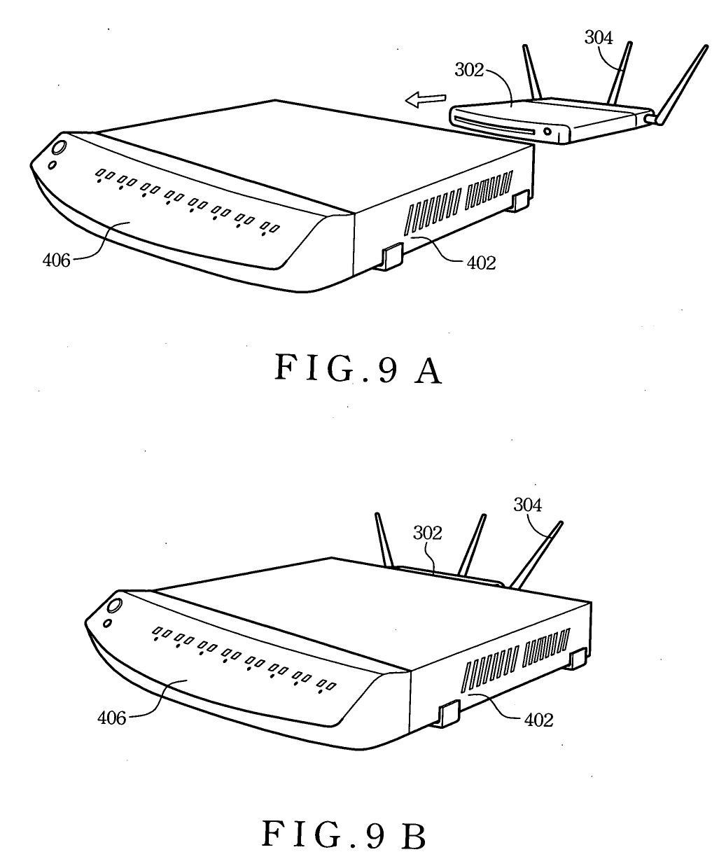

FIG. 9A is a lateral side view of the wireless network system of the present invention, illustrating a prior state, in which, the wireless base station 302 is not inserted into the router 402. FIG. 9B is a perspective side view of the wireless network system of the present invention, wherein; the wireless base station 302 is inserted into a rear side of the router 402 for electrically coupling together. Note that the router 402 has a rear side formed with an accommodating recess 410 for accommodating the wireless base station 302 except the antenna unit 304. In other words, the antenna unit 304 is exposed and extends outwardly from the wireless base station 302.

Once the wireless base station 302 and the router 402 are connected to each other in the abovementioned ways, the wireless network system of the present invention provides fine transmission quality. In case, the user desires to achieve a further better transmission quality, he can hang the wireless base station 302 high on a wall surface. Under this condition, an external connecting cable (not visible) is used for electrically coupling the wireless base station 302 to the router 402.

In one embodiment of the present invention, connection of the coupling portion 306 of the wireless base station 302 to the conducting portion 404 of the router 402 enables electrical power to flow into the wireless base station 302. However, when the router 402 is connected to the wireless base station 302 via a connection cable, the router 402 supplies electrical power for the wireless base station 302 via the connection cable.

From the aforementioned embodiments, it can be observed that the wireless base station and the router for forming the wireless network system of the present invention provides multiple connecting ways or can be separated from each other during the utility thereof depending on the environments. Moreover, the wireless network system serves as common wireless base station.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A wireless network system for communicating a wireless network with a destination, the wireless network system comprising:
a wireless base station for receiving or transmitting a data via the wireless network;
a coupling portion set on the wireless base station; and
a router having a conducting portion, which is electrically connected to the coupling portion for receiving or transmitting the data from or to the destination, the router being selectively connected with or disassembled from the wireless base station.

2. The wireless network system according to claim 1, wherein the wireless base station is connected electrically to the router in an up-and-down direction.

3. The wireless network system according to claim 2, wherein the router further comprises a supporting portion for supporting the wireless base station when the wireless base station is connected electrically to the router in the up-and-down direction.

4. The wireless network system according to claim 1, wherein the wireless base station is connected electrically to the router in a front-and-rear direction.

5. The wireless network system according to claim 4, wherein the wireless base station further comprises a foldable portion folded in a normal condition and unfolded in a use condition, and the foldable portion of the wireless base station being unfolded so as to be docked on the router when the wireless base station is connected electrically to the router along the front-and-rear direction.

6. The wireless network system according to claim 1, wherein the wireless base station and the router are connected to each other in a snap-fit manner.

7. The wireless network system according to claim 6, wherein the router is formed with an accommodating recess into which the coupling portion of the wireless base station being snap-fitted so as to connect with the wireless base station in the snap-fit manner.

8. The wireless network system according to claim 1, wherein the wireless base station is capped onto the router.

9. The wireless network system according to claim 8, wherein the router is formed with an accommodating recess for accommodating the wireless base station when the wireless base station is capped onto the router.

10. The wireless network system according to claim 1, wherein the wireless base station is inserted into a rear side of the router for electrically connecting to the router.

11. The wireless network system according to claim 10, wherein the rear side of the router is formed with an accommodating recess for accommodating partially the wireless base station.

12. The wireless network system according to claim 10, wherein the wireless base station is formed with an antenna unit.

13. The wireless network system according to claim 12, wherein the antenna unit is exposed and extends outwardly from the wireless base station.

14. The wireless network system according to claim 1, further comprising a connecting cable for electrically coupling the wireless base station to the router.

15. The wireless network system according to claim 1, wherein connection of the coupling portion of the wireless base station with the conducting portion of the router enables electrical power to flow into the wireless base station.

16. A wireless base station for transmitting or receiving a data via a wireless network, the wireless base station comprising:
a coupling portion for electrically connecting with a router in order to receive or transmit the data to a destination.

17. A router comprising:
a router having a conducting portion which is electrically connected to a wireless base station for receiving or transmitting a data from or to a destination.
